(19) United States
(12) Patent Application Publication
(10) Pub. No.: US 2015/0120120 A1
(43) Pub. Date: Apr. 30, 2015

(54) ELECTRIC DRIVE VEHICLE

(71) Applicant: TOYOTA JIDOSHA KABUSHIKI KAISHA, Toyota-shi (JP)

(72) Inventor: Takashi OTA, Toyota-shi (JP)

(21) Appl. No.: 14/520,460

(22) Filed: Oct. 22, 2014

(30) Foreign Application Priority Data
Oct. 29, 2013 (JP) 2013-223846

(51) Int. Cl. B60W 20/00; B60W 10/08; H02P 23/08; B60W 30/18

(52) U.S. Cl. CPC B60W 20/108; B60W 30/18127; B60W 10/08; H02P 23/08
USPC 701/22

(57) ABSTRACT

During traveling of an electric drive vehicle 100, if a quantity of regenerative power generated by a synchronous motor generator 40 is greater than a first predetermined value, a slip frequency S of an induction motor generator 50 is changed while maintaining a torque output of the induction motor generator 50, thereby increasing power consumption by the induction motor generator 50. With this structure, it is possible to effectively protect electric devices when excessive power regeneration occurs.

### PRIORITY INFORMATION

This application claims priority to Japanese Patent Application No. 2013-223846, filed on Oct. 29, 2013, which is incorporated herein by reference in its entirety.

### BACKGROUND

1. Technical Field

The present invention relates to a structure of an electric drive vehicle and also to a method of adjusting a quantity of power of an electric drive vehicle.

2. Background Art

In recent years, electric drive vehicles including electric cars driven by a motor generator serving as a drive source, and hybrid vehicles driven by an engine and a motor generator serving as drive sources, are being used. The electric drive vehicles often adopt a method of converting direct current power supplied from a chargeable/dischargeable secondary cell (battery) mounted in the vehicle into alternating current power such as three-phase alternating current power and so on using an inverter, and supplying the alternating current power to a vehicle driving motor generator during traveling and converting alternating current power generated by the motor generator into direct current power for charging the battery (power regeneration) during deceleration. Many of the electric drive vehicles include, as a vehicle driving motor generator, a synchronous motor generator alone or in combination with an induction motor generator. Among these types of electric drive vehicle are electric drive vehicles in which front wheels are driven by a synchronous motor generator and an induction motor generator and rear wheels are driven by an induction motor generator, or electric drive vehicles in which front wheels are driven by a synchronous motor generator and rear wheels are driven by an induction motor generator (see JP 2009-268265 A, for example).

### SUMMARY

### Technical Problems

Slip of an electric drive vehicle during traveling may cause a sudden increase the rotation speed of the wheels to thereby further cause a sudden increase in the regenerative electric power which is supplied to the battery from the motor generator, resulting in an excessive quantity of the regenerative electric power. In this case, due to excessive voltage applied to the battery and the inverter, a boost converter, and so on and also due to excessive electric current, lives of the electric devices such as the battery, inverter, boost converter, and so on, may be shortened.

The present invention is therefore aimed at effectively protecting an electric device when excessive power regeneration occurs in an electric drive vehicle.

### Means for Solving the Problems

In accordance with an aspect of the invention, an electric drive vehicle includes a battery, at least one vehicle driving induction motor generator, at least one other vehicle driving motor generator, and a control unit that adjusts a quantity of electric power to be supplied from the battery to the at least one vehicle driving induction motor generator and the at least one other vehicle driving motor generator and a quantity of regenerative power to the battery from the at least one vehicle driving induction motor generator and the at least one other vehicle driving motor generator. The control unit includes first slip frequency changing means that changes a slip frequency of the at least one vehicle driving induction motor generator while maintaining a torque output of the at least one vehicle driving induction motor generator, if the quantity of regenerative power generated by the at least one other vehicle driving motor generator is equal to or greater than a first predetermined value, during traveling of the electric drive vehicle.

Preferably, in the electric drive vehicle according to the present invention, the control unit may include second slip frequency changing means that changes the slip frequency of the at least one vehicle driving induction motor generator without maintaining the torque output of the at least one vehicle driving induction motor generator, if the quantity of regenerative power generated by the at least one other vehicle driving motor generator is equal to or greater than a second predetermined value which is greater than the first predetermined value, during traveling of the electric drive vehicle.

In accordance with another aspect of the invention, an electric drive vehicle includes a battery, at least one vehicle driving induction motor generator, at least one other vehicle driving motor generator, and a control unit that includes a CPU and adjusts a quantity of electric power to be supplied from the battery to the at least one vehicle driving induction motor generator and the at least one other vehicle driving motor generator and a quantity of regenerative power to the battery from the at least one vehicle, driving induction motor generator and the at least one other vehicle driving motor generator. The control unit executes, using the CPU, a first slip frequency changing program that changes a slip frequency of the at least one vehicle driving induction motor generator while maintaining a torque output of the at least one vehicle driving induction motor generator, if the quantity of regenerative power generated by the at least one other vehicle driving motor generator is equal to or greater than a first predetermined value, during traveling of the electric drive vehicle.

In accordance with still another aspect of the invention, in an electric drive vehicle comprising a battery, at least one vehicle driving induction motor generator, and at least one other vehicle driving motor generator, a method of adjusting a quantity of electric power to be supplied from the battery to the at least one vehicle driving induction motor generator and the at least one other vehicle driving motor generator and a quantity of regenerative power to the battery from the at least one vehicle driving induction motor generator and the at least one other vehicle driving motor generator includes changing a slip frequency of the at least one vehicle driving induction motor generator while maintaining a torque output of the at least one vehicle driving induction motor generator, if the quantity of regenerative power generated by the at least one other vehicle driving motor generator is equal to or greater than a first predetermined value, during traveling of the electric drive vehicle.

### Advantage of the Invention

The present invention can achieve the advantage of effectively protecting an electric device when excessive power regeneration occurs in an electric drive vehicle.

### BRIEF DESCRIPTION OF THE DRAWINGS

A preferred embodiment of the present invention will be described in detail based on the following figures, wherein:

FIG. 1 is a system diagram illustrating a structure of an electric drive vehicle according to the present invention;

FIG. 2 is a flow chart illustrating an operation of the electric drive vehicle according to the present invention;

FIG. 3 is a flow chart continued from FIG. 2, illustrating a further operation of the electric drive vehicle according to the present invention;

FIG. 4 shows characteristics curves of the torque, slip frequency, and electric current, and control curves of the slip frequency with respect to torque command of an induction motor generator used in the electric drive vehicle according to the present invention;

FIG. 5 is a map showing a slip frequency correction amount ΔS with respect to a low voltage VL in the electric drive vehicle according to the present invention; and

FIG. 6A is a graph showing temporal changes of the low voltage VL in the electric drive vehicle according to the present invention.

FIG. 6B is a graph showing temporal changes of the induction motor generator torque command T in the electric drive vehicle according to the present invention.

FIG. 6C is a graph showing temporal changes of the slip frequency correction amount ΔS in the electric drive vehicle according to the present invention.

FIG. 6D is a graph showing temporal changes of the slip frequency S in the electric drive vehicle according to the present invention.

### DESCRIPTION OF EMBODIMENTS

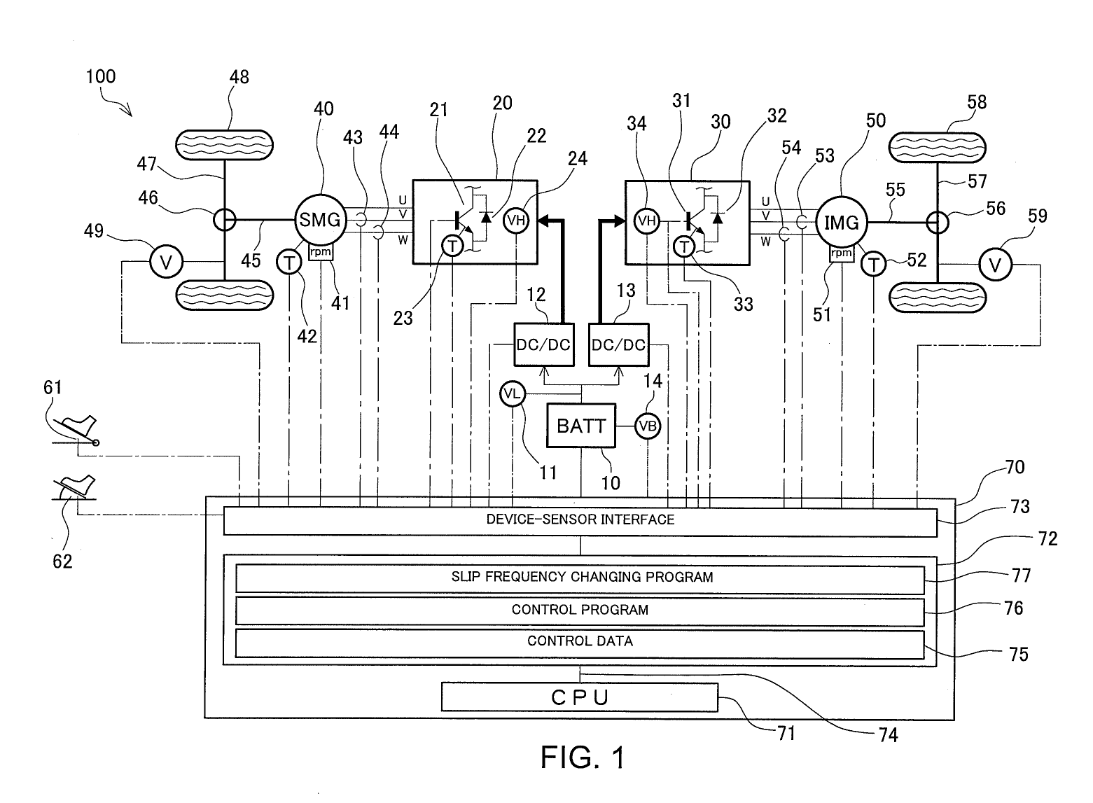

A preferred embodiment of the present invention will be described in detail with reference to the accompanying drawings. As illustrated in FIG. 1, an electric drive vehicle 100 according to the present embodiment includes front wheels 48 driven by a synchronous motor generator 40 and rear wheels 58 driven by an induction motor generator 50. The synchronous motor generator 40 may be a permanent magnet synchronous motor generator (PMSMG) having a permanent magnet incorporated in a rotor.

As illustrated in FIG. 1, a voltage of direct current power supplied from a battery 10 which is a chargeable/dischargeable secondary cell is boosted by a boost converter 12 and boosted direct current power thus obtained is then converted, by an inverter 20, into three-phase alternating current power which is then supplied to the synchronous motor generator 40. Further, a voltage of direct current power supplied from the common battery 10 is boosted by a boost converter 13 and boosted direct current power thus obtained is then converted, by an inverter 30, into three-phase alternating current power which is then supplied to the induction motor generator 50. A voltage sensor 11 for detecting a voltage (low voltage VL) of the battery 10 is provided between the battery 10 and the boost converters 12 and 13. Also, a voltage sensor 14 for directly detecting a voltage of the battery 10 is provided in the battery 10.

The inverter 20 includes therein a total of six switching elements including an upper arm switching element and a lower arms switching element for each of U phase, V phase, and W phase. A diode 22 is connected to each switching element 21 in an antiparallel connection and a temperature sensor 23 is attached to each switching element 21 for detecting the temperature of the switching element 21. FIG. 1 illustrates only one of the six switching elements, one of the six diodes, and one of the six temperature sensors, and does not show the remaining switching elements, diodes, or temperature sensors. The inverter 20 also includes a smoothing capacitor (not shown) which forms the boosted direct current power supplied from the boost converter 12 into smooth direct current power, and a voltage sensor 24 for detecting voltage (high voltage VH) at both ends of the smoothing capacitor, that are mounted therein. Output lines for outputting electric current of the U phase, V phase, and W phase, respectively, are provided between the upper arm switching element and the lower arm switching element of each of the U, V, and W phases of the inverter 20, and each of the output lines is connected to an input terminal of each of the U, V, and W phases of the synchronous motor generator 40. In the present embodiment, current sensors 43 and 44 are attached to the output lines of V phase and W phase, respectively, for detecting the electric currents of V phase and W phase, respectively. While a current sensor is not attached to the output line of U phase, as a sum of the electric currents of U, V, and W phases is zero, the electric current of U phase can be obtained based on calculation of the electric currents of V phase and W phase, in the absence of the current sensor attached to the U phase output line.

An output shaft 45 of the synchronous motor generator 40 is connected to a drive mechanism 46 such as a differential gear or a reduction gear. The drive mechanism 46 converts a torque output of the synchronous motor generator 40 to a drive torque of a front axle 47 for driving the front wheels 48. The axle 47 includes a vehicle speed sensor 49 for detecting the vehicle speed from the rotation speed of the axle 47. A resolver 41 for detecting the rotation angle or the rotation speed of the rotor and a temperature sensor 42 for detecting the temperature of the synchronous motor generator 40 are mounted on the synchronous motor generator 40.

Similar to the synchronous motor generator 40, a voltage of direct current power supplied from the battery 10 is boosted by a boost converter 13 and boosted direct current power thus obtained is then converted, by an inverter 30, into three-phase alternating current power which is then supplied to the induction motor generator 50. The structures of the inverter 30 (a switching element 31, a diode 32, a voltage sensor 34, and a temperature sensor 33), current sensors 53 and 54, a resolver 51, and a temperature sensor 52 are similar to those of the inverter 20, the current sensors 43 and 44, the resolver 41, and the temperature sensor 42, which are used for driving the synchronous motor generator 40 described above. An output shaft 55 of the induction motor generator 50 is, similar to the output shaft 45 of the synchronous motor generator 40, connected to a drive mechanism 56 such as a differential gear or a reduction gear, and the drive mechanism 56 is connected to a rear axle 57 for driving rear wheels 58. A vehicle speed sensor 59 is attached to the axle 57, as with the axle 47.

The electric drive vehicle 100 according to the present embodiment further includes an accelerator pedal depression amount detection sensor 61 and a brake pedal depression amount detection sensor 62 which detect a depression amount of the accelerator pedal and a depression amount of the brake pedal, respectively.

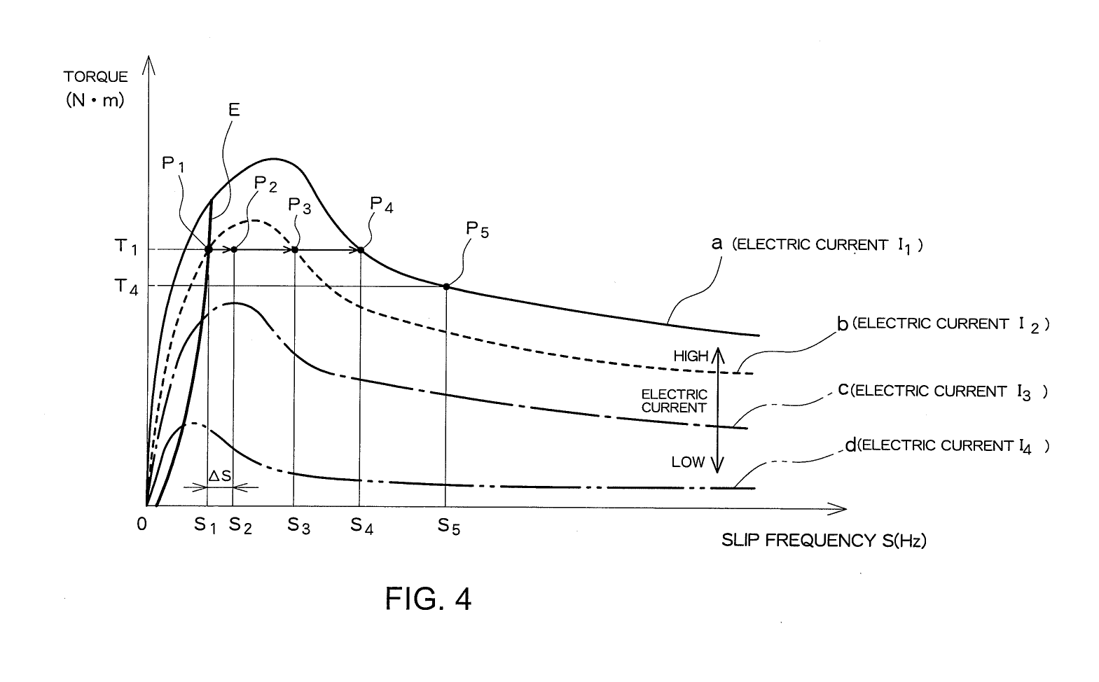

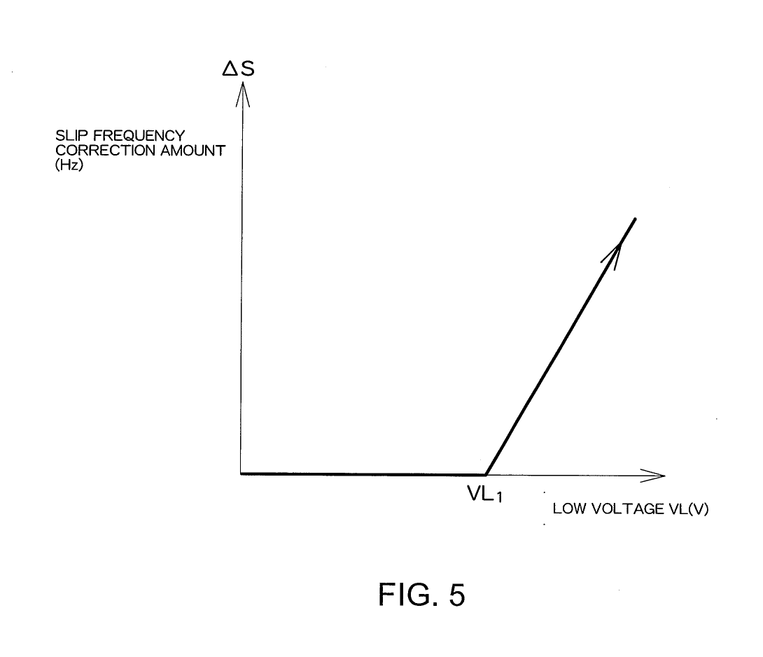

As illustrated in FIG. 1, a control unit 70 is a computer including a CPU 71 which executes calculation processing, a storage section 72, and a device-sensor interface 73, which are connected via a data bus 74. The storage section 72 stores therein control data 75, a control program 76, and a slip frequency changing program 77, which will be described below, of the electric drive vehicle 100. The slip frequency changing program 77 includes a map for specifying a slip frequency correction amount ΔS with respect to low voltage VL shown in FIG. 5. The optimal efficiency line E and characteristics curves (a) to (d) of the induction motor generator 50 shown in FIG. 4, which will be described below, are stored in the control data 75. The battery 10, the boost converters 12 and 13, and the switching elements 21 and 31 of the inverters 20 and 30, respectively, which have been described above, are connected to the control unit 70 via the device-sensor interface 73 so as to operate in accordance with a command from the control unit 70. Further, the voltage sensors 11, 14, 24, and 34, the temperature sensors 23, 33, 42, and 52, the current sensors 43, 44, 53, and 54, the resolvers 41 and 51, the vehicle speed sensors 49 and 59, the accelerator pedal depression amount sensor 61 and the brake pedal depression amount sensor 62 are configured such that the outputs from the respective sensors are input to the control unit 70 through the device-sensor interface 73.

An operation of the electric drive vehicle 100 according to the present embodiment which has been described above will be described. In the description below, the following example case is assumed: due to slip of the front wheels 48 of the electric drive vehicle 100, the quantity of regenerative power from the synchronous motor generator 40 increases to exceed a first threshold value, so that the low voltage VL, which is an output voltage of the battery 10, is a first predetermined value VL₁ or greater, and the slip of the front wheels 48 continues to further increase the quantity of regenerative power from the synchronous motor generator 40 to exceed a second threshold value, so that the low voltage VL, which is an output voltage of the battery 10, is a second predetermined value VL₂ or greater.

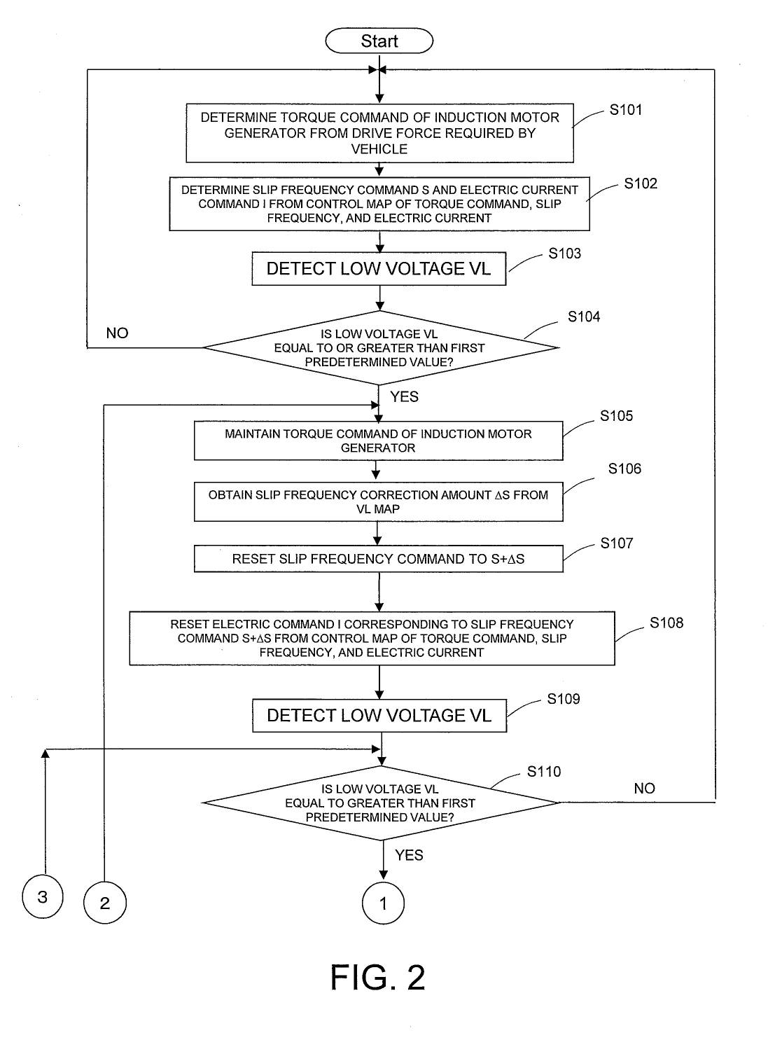

The control unit 70, as indicated in step S101 in FIG. 2, calculates an output torque command T of the induction motor generator 50 which drives the rear wheels 58, on the basis of running data of the electric drive vehicle 100 including a depression amount of the accelerator pedal from a driver obtained by the accelerator pedal depression amount detection sensor 61 and the vehicle speed detected by the vehicle speed sensors 49 and 59, and other data. Then, as indicated in step S102 of FIG. 2, the control unit 70 obtains an electric current command I and a slip frequency S[Hz] from the torque command T which has been previously calculated, on the basis of the optimal efficiency line E of the torque command T and the slip frequency S of the induction motor generator 50 shown in FIG. 4.

Here, the control of the induction motor generator 50 will be described with reference to FIG. 4. In FIG. 4, a solid line (a), a broken line (b), an alternate long and short dash line (c), and a two-dot chain line (d) are characteristics curves, each representing a relationship between the torque output and the slip frequency S at electric currents I₁, I₂, I₃, and I₄ (I₁>I₂>I₃>I₄), respectively, supplied to the induction motor generator 50. The solid line (a) in FIG. 4 is a characteristic curve obtained when the electric current I₁ flowing in a stator coil is the maximum electric current. As shown by the lines (a) to (d) in FIG. 4, the torque output of the induction motor generator 50 is zero when the slip frequency S is zero, that is, when a difference between the electric frequency [Hz] of the rotor caused by rotation of the rotor and the electric frequency [Hz] of the electric current flowing in the stator coil is zero. As the slip frequency S increases, that is, as the difference between the electric frequency [Hz] of the rotor caused by rotation of the rotor and the electric frequency [Hz] of the electric current flowing in the stator coil increases, the torque output also increases. When the slip frequency S continues to increase and reaches a certain level, the torque output becomes maximum, and with a further increase in the slip frequency S, the torque output decreases. Further, the greater the electric current I flowing in the stator coil, the greater the torque output, and the smaller the electric current I, the smaller the torque output.

The bold solid line E in FIG. 4 is an optimal efficiency line E obtained by connecting points of the electric current I and the slip frequency S which are most effective for obtaining a certain torque output when driving the induction motor generator 50 having the characteristics as described above. Accordingly, if the operation point of the induction motor generator 50 is off the optimal efficiency line E, the efficiency of the induction motor generator 50 decreases to increase the power consumption for obtaining the same output. During normal control, the control unit 70, in response to a required torque, determines the electric current value I[A] supplied to the stator coil and the slip frequency S[Hz] along this optimal efficiency line E. The control unit 70 calculates an electric frequency Fᵣ[Hz] of the rotor from the rotation speed of the rotor of the induction motor generator 50 detected by the resolver 51, and further calculates an electric frequency Fₛ[Hz] by adding the slip frequency S[Hz] which has been already obtained to the calculated electric frequency Fᵣ[Hz]. The control unit 70 then actuates the inverter 30 to supply an alternating current of the electric current I[A] to the stator coil of the induction motor generator 50 at the electric frequency Fₛ[Hz], to cause the stator coil to generate a torque or driving force in accordance with the running state. As illustrated in FIG. 4, because, when the torque command T is T₁, the slip frequency is S₁ and the electric current is electric current I₂ represented by the characteristic curve indicated by the broken line (b) based on the optimal efficiency line E shown in FIG. 4, the control unit 70 calculates the electric frequency F₆[Hz] by adding the slip frequency S₁[Hz] to the electric frequency Fᵣ[Hz] of the rotor and actuates the inverter 30 to supply an alternating current of the electric current I₂[A] to the stator coil of the induction motor generator 50 at the electric frequency Fₛ[Hz].

Further, the control unit 70 calculates a torque command Tₛ of the synchronous motor generator 40 based on the running data of the electric drive vehicle 100. Based on the output torque command Tₛ of the synchronous motor generator 40 thus calculated, the control unit 70 obtains, from the control map, the waveform of the three-phase alternating current power and the voltage supplied to the stator of the synchronous motor generator 40, and actuates the inverter 20 and the boost converter 12 to supply the three-phase alternating current power with the waveform and the voltage to the synchronous motor generator 40 for generating the torque or driving force in accordance with the running state.

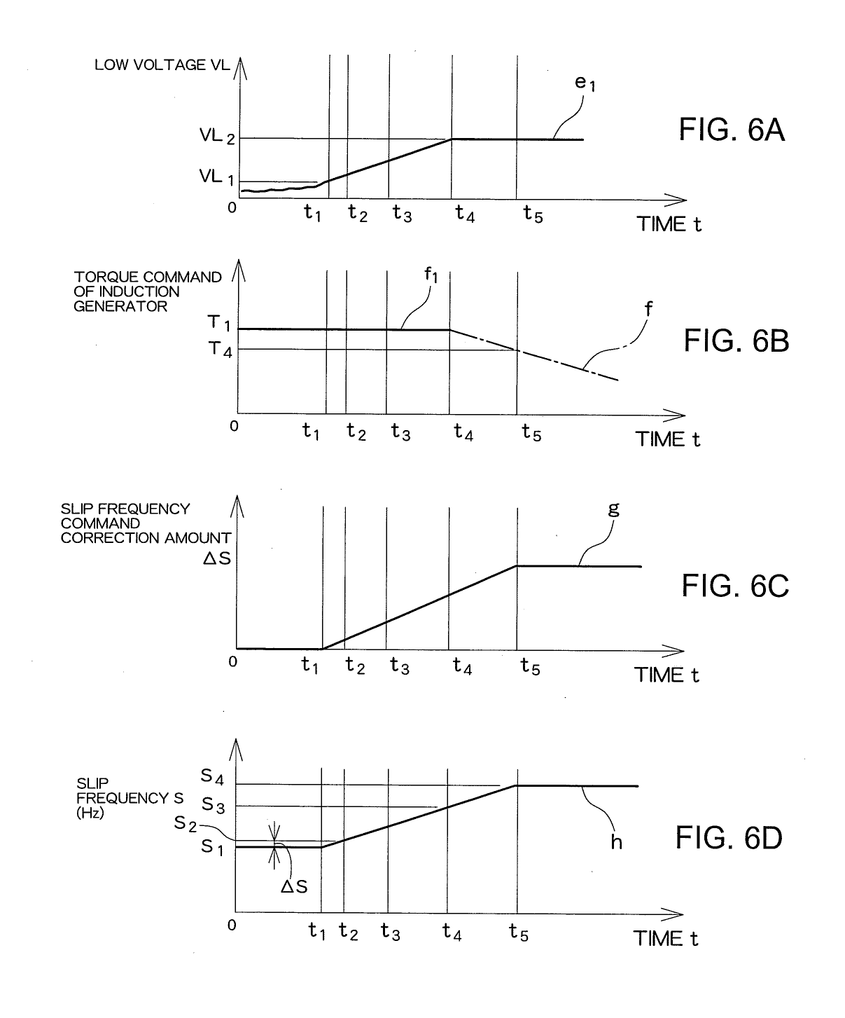

As indicated in step S103 of FIG. 2, the control unit 70 detects the low voltage VL which is an output voltage of the battery 10 by the voltage sensor 11 illustrated in FIG. 1. The control unit 70 then determines whether or not the low voltage VL is equal to or greater than the first predetermined value VL₁, as shown in step S104 of FIG. 2. If the low voltage VL is not equal to or greater than the first predetermined value VL₁ (i.e. the low voltage VL is less than the first predetermined value VL₁), the control unit 70, determining that the quantity of the regenerative power from the synchronous motor generator 40 is less than the first threshold value, returns to step S101 of FIG. 2 to continue normal control. At this time, the torque command T of the induction motor generator 50 is T₁, and the control unit 70 calculates the electric frequency F₅[Hz] by adding the slip frequency S₁[Hz] to the electric frequency Fᵣ[Hz] of the rotor and actuates the inverter 30 to supply an alternating current of the electric current I₂[A] to the stator coil of the induction motor generator 50 at the electric frequency F₃[Hz]. The induction motor generator 50 is operating at point P₁ shown in FIG. 4. If the low voltage VL is equal to or greater than the first predetermined value VL₁ at a time t₁ shown in FIGS. 6A to 6D, the control unit 70, determining that due to slip of the front wheels 48 the quantity of the regenerative power from the synchronous motor generator 40 is equal to or greater than the first threshold value, executes a first slip frequency changing program (first slip frequency changing means) in the slip frequency changing program 77 illustrated in FIG. 1, as indicated in steps S105 to S108 in FIG. 2.

The control unit 70 maintains the torque command T of the induction motor generator 50 to a fixed level as indicated in step S105 of FIG. 2, and obtains a slip frequency correction amount ΔS from the map illustrated in FIG. 5 as indicated in step S106 of FIG. 2 to increase the slip frequency by ΔS, as indicated in step S107 of FIG. 2.

More specifically, when the low voltage VL is equal to or greater than the first predetermined value VL₁, the control unit 70 obtains the slip frequency correction amount ΔS from the map which specifies the slip frequency correction amount ΔS with respect to the low voltage VL illustrated in FIG. 5. As illustrated in FIG. 5, the slip frequency correction amount ΔS with respect to the low voltage VL remains zero until the low voltage VL reaches the first predetermined value VL₁, and, when the low voltage VL becomes equal to or greater than the first predetermined value VL₁, increases as the low voltage VL increases. The control unit 70 increases the slip frequency S from S₁ by an amount of ΔS as indicated by line (h) in FIG. 6D between the time t₁ and time t₂ shown in FIGS. 6C and 6D, and resets the slip frequency S to S₂=(S₁+ΔS) at time t₂ in FIGS. 6A to 6D, as shown in step S107 in FIG. 2. At this time, as the torque command T is maintained at T₁ at time t₁ shown in FIG. 6B, the control unit 70, as shown in step S108 of FIG. 2, reduces the electric current command from I₂ at time t₁ such that the operation point of the induction motor generator 50 changes from point P₁ to point P₂ shown in FIG. 4. In other words, the control unit 70 increases the slip frequency S and reduces the electric current I such that the output torque of the induction motor generator 50 is maintained at T₁.

As, with the above setting, at time t₂ in FIGS. 6A to 6D, the operation point of the induction motor generator 50 is at point P₂ which is shifted from point P₁ on the optimal efficiency line E shown in FIG. 4, the operation efficiency of the induction motor generator 50 is reduced and the power required for the torque output T₁ (torque command T₁) increases. Accordingly, the induction motor generator 50 can consume more regenerative power from the synchronous motor generator 40. As a result, the regenerative power from the synchronous motor generator 40 which is supplied to the battery 10 for charging can be reduced, so that the low voltage VL which is an output voltage of the battery 10 can be reduced. Further, the torque output of the induction motor generator 50 is maintained at the original torque command T₁ as indicated by line f₁ in FIG. 6B.

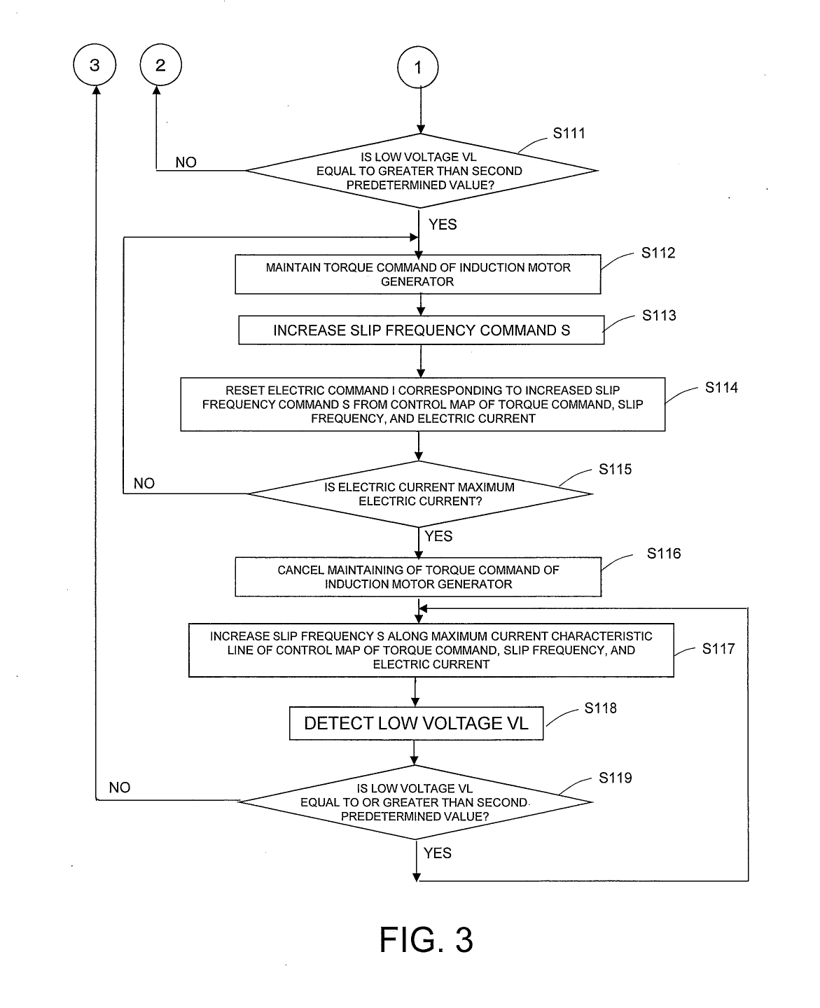

Next, as indicated in step S109 of FIG. 2, the control unit 70 detects the low voltage VL again at time t₂ in FIG. 6 and determines whether or not the low voltage VL is equal to or greater than the first predetermined value VL₁. If the low voltage VL is not equal to or greater than the first predetermined value VL₁, that is, if the low voltage VL is less than the first predetermined value VL₁, the control unit 70, determining that the slip of the front wheels 48 is terminated and the quantity of the regenerative power from the synchronous motor generator 40 is less than the first threshold value, returns to step S101 of FIG. 2 to continue normal control. If the state in which the low voltage VL is equal to or greater than the first predetermined value VL₁ remains as shown by line e₁ in FIG. 6A, the control unit 70 then determines whether or not the low voltage VL is equal to or greater than the second predetermined value VL₂ as shown in step S111 in FIG. 3. If the low voltage VL is equal to or greater than the first predetermined value VL₁ and is also less than the second predetermined value VL₂ as indicated between time t₂ and time t₃ in FIG. 6A, the process returns to step S105 in FIG. 2 to increase the slip frequency correction amount ΔS to thereby increase the slip frequency S as indicated by line (g) shown in FIG. 6C and line h shown in FIG. 6D, and reset the electric current I so as to move the operation point of the induction motor generator 50 from point P₂ to point P₃ shown in FIG. 4, while maintaining the torque command T at T₁. While the control unit 70 has reduced the electric current I for moving the operation point of the induction motor generator 50 from point P₁ to point P₂ shown in FIG. 4, the control unit 70 increases the electric current I for moving the operation point of the induction motor generator 50 from point P₂ to point P₃ and resets the electric current to the original electric current I₂ at P₃. Then, when the operation point of the induction motor generator 50 shifts to point P₃ shown in FIG. 4 at time t₃ in FIG. 6A, the control unit 70 detects the low voltage VL once again as shown in step S109. If the low voltage VL is equal to or greater than the first predetermined value VL₁ and is also less than the second predetermined value VL₂, the process returns once again to step S105 in FIG. 2 to increase the slip frequency S and reset the electric current I so as to move the operation point of the induction motor generator 50 from point P₃ to point P₄ shown in FIG. 4, while maintaining the torque command T of the induction motor generator 50 at T₁ (between time t₃ and time t₄ in FIG. 6B). At this time, the control unit 70 increases the slip frequency S and also increases the electric current I, and controls such that the torque output of the induction motor generator 50 is maintained at the original torque command T₁ as shown by line f₁ in FIG. 6B.

With the above setting, at time t₃ and time t₄ in FIGS. 6A to 6D, as the operation point of the induction motor generator 50 is located at point P₃ or point P₄ which is further away from point P₁ on the optimal efficiency line E shown in FIG. 4, the operation efficiency of the induction motor generator 50 further decreases and the electric power required for the torque output T₁ (torque command T₁) further increases, so that the induction motor generator 50 can consume a greater amount of the regenerative power from the synchronous motor generator 40. This results in a further reduction in the regenerative power from the synchronous motor generator 40 to be supplied to the battery 10 for charging, so that the low voltage VL, which is an output voltage of the battery 10, can be further reduced. Then, as shown in step S110 in FIG. 2, when the low voltage VL is less than the first predetermined value VL₁, the control unit 70, determining that the slip of the front wheels 48 is terminated and the quantity of the regenerative power from the synchronous motor generator 40 is less than the first threshold value, causes the process to return to step S101 of FIG. 2 to perform normal control.

On the other hand, if the low voltage VL is equal to or greater than the second predetermined value VL₂ at time t₄ in FIG. 6A, as shown in step S111 in FIG. 3 and as shown by line e₁ in FIG. 6A, the control unit 70, determining that the quantity of the regenerative power from the synchronous motor generator 40 is equal to or greater than the second threshold value due to slip of the front wheels 48, increases the slip frequency S, resets the electric current I, and moves the operation point of the induction motor generator 50 in a direction toward the right side in the horizontal direction away from the point P₁ on the optimal efficiency line E shown in FIG. 4 while maintaining the torque command T of the induction motor generator 50 at T₁, similar to steps S105 through S108 in FIG. 2, as shown in steps S112, S113, and S114 of FIG. 3. Then, when the electric current I becomes the maximum electric current as shown in step S115 of FIG. 3, a second slip frequency changing program (a second slip frequency change means) in the frequency changing program 77 is executed, as shown in steps S116 to S117 in FIG. 3. In the present embodiment, as the operation point of the induction motor generator 50 is located at the point P₄ on the characteristic curve of the maximum electric current at I₁ at time t₄ in FIG. 6B, the control unit 70, determining that the electric current supplied to the induction motor generator 50 reaches the maximum electric current at time t₄ in FIG. 6B, cancels the operation for maintaining the torque command of the induction motor generator 50 which is set in steps S105 and S112 in FIG. 2 at time t₄ in FIG. 6B, as shown in step S116 in FIG. 3, and changes the slip frequency S along line (a), which is a characteristic curve at the maximum electric current I₁ shown in FIG. 3 during a time period from time t₄ to time t₅ in FIGS. 6A to 6D, as shown in step S117 of FIG. 3. At this time, the electric current is fixed to the maximum electric current and the torque output of the induction motor generator 50 gradually decreases from the original torque command T₁ as shown by the alternate long and short dash line (f) in FIG. 6B, and reaches T₄ at time t₅ (the torque output T₄ at point P5 in FIG. 4).

With the above setting, at time t₅ in FIGS. 6A to 6D, as the operation point of the induction motor generator 50 is located at point P₅ which is the most distant from point P₁ on the optimal efficiency line E shown in FIG. 4, the operation efficiency of the induction motor generator 50 further decreases and the electric power required for the torque output T₁ (torque command T₁) further increases, so that the induction motor generator 50 can consume a greater amount of the regenerative power from the synchronous motor generator 40. This results in a further reduction in the regenerative power from the synchronous motor generator 40 to be supplied to the battery 10 for charging, so that the low voltage VL, which is an output voltage of the battery 10, can be further reduced.

The control unit 70 detects the low voltage VL again at time t₅ shown in FIGS. 6A to 6D as shown in step S118 of FIG. 3, and if the low voltage VL is equal to or greater than the second predetermined value VL₂, causes the process to return to step S117 to increase the slip frequency S along the line (a) which is a characteristic curve at the maximum electric current I₁ shown in FIG. 4. If the low voltage VL is less than the second predetermined value VL₂, the control unit 70 causes the process to return to step S110 in FIG. 2 to further determine whether or not the low voltage VL is less than the first predetermined value VL₁. If the low voltage VL is less than the first predetermined value VL₁, the control unit 70, determining that the slip of the front wheels 48 is terminated and the quantity of the regenerative power from the synchronous motor generator 40 is less than the first threshold value, causes the process to return to step S101 of FIG. 2 to perform normal control. If the low voltage VL is equal to or greater than the second predetermined value VL₁ and is also less than the second predetermined value VL₂, the control unit 70 executes the first slip frequency changing program (the first slip frequency change means) to increase the slip frequency S with the torque command T of the induction motor generator 50 being held at a fixed level as illustrated in steps S112 to 114 of FIG. 3, through step S110 of FIG. 2 and step S111 of FIG. 3.

As described above, according to the present embodiment, as, if the low voltage VL exceeds a predetermined value, the operation point of the induction motor generator 50 is deviated from point P₁ on the optimal efficiency line E shown in FIG. 4, the operation efficiency of the induction motor generator 50 decreases and the electric power required for the output torque T₁ (torque command T₁) increases, so that the induction motor generator 50 can consume a greater amount of the regenerative power from the synchronous motor generator 40. With this structure, it is possible to reduce the electric power flowing into the battery 10 when excessive power regeneration occurs, to thereby prevent a rise in the low voltage VL so that electric components such as the battery 10 and so on can be effectively protected. Further, as the output torque of the induction motor generator 50 can be maintained at the original torque command T₁ as illustrated by line f₁ in FIG. 6B, stability of the vehicle can be maintained even in a state of slip of the front wheels 48. Also, according to the present embodiment, when the low voltage VL, which is an output voltage of the battery 10, is equal to or greater than the second predetermined value VL₂, the slip frequency S is increased and the operation efficiency of the induction motor generator 50 is rapidly decreased to rapidly increase the quantity of the regenerative power from the synchronous motor generator 40 to be consumed by the induction motor generator 50, irrespective of the output torque of the induction motor generator 50. Consequently, even if further excessive power regeneration occurs, it is possible to further reduce the electric power flowing into the battery 10 to prevent a rise in the low voltage VL, thereby effectively protecting electric components such as the battery 10 and so on.

In the above description of the embodiment, whether or not the low voltage VL which is an output voltage of the battery 10 is equal to or greater than the first predetermined value VL₁ or the second predetermined value VL₂ is used as a criterion for determining whether or not the quantity of the regenerative power from the synchronous motor generator 40 rises to the first threshold value or greater or to the second threshold value or greater. Alternatively, it is also possible to detect the quantity of the regenerative power from the synchronous motor generator 40 by the electric current sensors 43 and 44 and use a determination result as to whether or not the quantity of the regenerative power which is detected rises to the first threshold value or greater or to the second threshold value or greater as a criterion for executing the first slip frequency reduction program (the first slip frequency reduction means) or the second slip frequency reduction program (the second slip frequency reduction means). Also, the voltage VB of the battery 10 may be detected by the voltage sensor 14, in place of the low voltage VL, to execute the first slip frequency reduction program (the first slip frequency reduction means) or the second slip frequency reduction program (the second slip frequency reduction means). In addition, while in the present embodiment described above, a single synchronous motor generator 40 and a single induction motor generator 50 are used, the electric drive vehicle 100 may include a plurality of synchronous motor generators and a plurality of induction motor generators. For example, the present invention is applicable to the electric drive vehicle 100 which is configured to drive the front wheels 48 with the synchronous motor generator 40 and the induction motor generator 50 and drive the rear wheels 58 with other synchronous motor generators 40 and other induction motor generators 50. When the electric drive vehicle 100 includes a plurality of synchronous motor generators and a plurality of induction motor generators, whether or not a total quantity of the regenerative powers from the plurality of synchronous motor generators 40 is a predetermined threshold value or greater may be used for executing the first slip frequency reduction program (the first slip frequency reduction means) or the second slip frequency reduction program (the second slip frequency reduction means), or whether or not the quantity of the regenerative power from each synchronous motor generator is equal to or greater than each predetermined threshold value may be used as a criterion for executing the first slip frequency reduction program (the first slip frequency reduction means) or the second slip frequency reduction program (the second slip frequency reduction means). The first and second slip frequency reduction programs (the first and second slip frequency reduction means) may change the slip frequency of one or a plurality of induction motor generators 50.

While the preferred embodiment of the present invention has been described using specific terms, such description is for illustrative purposes only, and it is to be understood that changes and variations may be made without departing from the spirit or scope of the appended claims.

What is claimed is:

1. An electric drive vehicle, comprising:
a battery;
at least one vehicle driving induction motor generator;
at least one other vehicle driving motor generator; and
a control unit that adjusts a quantity of electric power to be supplied from the battery to the at least one vehicle driving induction motor generator and the at least one other vehicle driving motor generator, and a quantity of regenerative power to the battery from the at least one vehicle driving induction motor generator and the at least one other vehicle driving motor generator;
the control unit including first slip frequency changing means that changes a slip frequency of the at least one vehicle driving induction motor generator while maintaining a torque output of the at least one vehicle driving induction motor generator, if the quantity of regenerative power generated by the at least one other vehicle driving motor generator is equal to or greater than a first predetermined value, during traveling of the electric drive vehicle.

2. The electric drive vehicle according to claim 1, wherein
the control unit includes:
second slip frequency changing means that changes the slip frequency of the at least one vehicle driving induction motor generator without maintaining the torque output of the at least one vehicle driving induction motor generator, if the quantity of regenerative power generated by the at least one other vehicle driving motor generator is equal to or greater than a second predetermined value which is greater than the first predetermined value, during traveling of the electric drive vehicle.

3. An electric drive vehicle, comprising:
a battery;
at least one vehicle driving induction motor generator;
at least one other vehicle driving motor generator; and
a control unit that includes a CPU and adjusts a quantity of electric power to be supplied from the battery to the at least one vehicle driving induction motor generator and the at least one other vehicle driving motor generator and a quantity of regenerative power to the battery from the at least one vehicle driving induction motor generator and the at least one other vehicle driving motor generator;
the control unit executing, using the CPU, a first slip frequency changing program that changes a slip frequency of the at least one vehicle driving induction motor generator while maintaining a torque output of the at least one vehicle driving induction motor generator, if the quantity of regenerative power generated by the at least one other vehicle driving motor generator is equal to or greater than a first predetermined value, during traveling of the electric drive vehicle.

4. In an electric drive vehicle comprising a battery, at least one vehicle driving induction motor generator, and at least one other vehicle driving motor generator,
a method of adjusting a quantity of electric power to be supplied from the battery to the at least one vehicle driving induction motor generator and the at least one other vehicle driving motor generator, and a quantity of regenerative power to the battery from the at least one vehicle driving induction motor generator and the at least one other vehicle driving motor generator;
the method comprising changing a slip frequency of the at least one vehicle driving induction motor generator while maintaining a torque output of the at least one vehicle driving induction motor generator, if the quantity of regenerative power generated by the at least one other vehicle driving motor generator is equal to or greater than a first predetermined value, during traveling of the electric drive vehicle.
